(19) United States
(12) Patent Application Publication
(10) Pub. No.: US 2020/0102111 A1
(43) Pub. Date: Apr. 2, 2020

(54) Recyclable Cup

(71) Applicant: Robin Thurgood, Derry, NH (US)

(72) Inventor: Robin Thurgood, Derry, NH (US)

(21) Appl. No.: 16/146,593

(22) Filed: Sep. 28, 2018

(51) Int. Cl. B65D 3/20; B65D 3/06; B65D 25/42; B31B 50/28; B31B 50/60

(52) U.S. Cl. CPC B65D 3/20; B65D 3/06; B31B 2120/302; B31B 50/28; B31B 50/60; B65D 25/42

(57) ABSTRACT

A cup is disclosed which may form its own closure. The cup is formed to define two flaps which may be folded inward to cover the cup opening. The flaps define a first drinking spout and a second vent spout to allow air to enter as fluid is removed. The present cup allows for a disposable cup to be formed of a single material without the need for a separate cover.

### BACKGROUND OF THE INVENTION

### Field of the Invention

The present invention relates generally to disposable cups. More particularly, the present invention relates to a cup which may form a closure for itself.

### Description of Related Art

Disposable beverage containers (hereinafter “cups”) are often formed of a plastic, Styrofoam, paper or similar product. These cups have a large top opening which often must be covered for portability purposes and to prevent spills. In almost all instances, the cover used is made of a plastic that is separate from and/or is a different material from the cup material. This is inconvenient, expensive, and creates excess waste.

Therefore, what is needed is cup which may form a closure for itself which allows a user to drink from the cup through the closure.

### SUMMARY OF THE INVENTION

The subject matter of this application may involve, in some cases, interrelated products, alternative solutions to a particular problem, and/or a plurality of different uses of a single system or article.

In one aspect, a cup is provided which can form its own closure. The cup is formed of a body having side walls and a base. Two arc-shaped score lines are formed into the body or by the body. The score lines define flaps on opposite sides of the cup. To create the closure for the cup, the two flaps are folded inward, at the score lines, over the cavity. In so folding and closing, a first drinking spout and a second vent spout are defined on diametrically opposite sides of the cup. The cup, so closed, allows a user to drink from the drinking spout while the cup remains otherwise closed (save for the vent spout).

In another aspect, a blank for forming into a cup is provided. The blank is formed of a sheet body, and two arcuate score lines formed on or by the sheet body. Each arcuate score line extends from a top edge of the sheet body, down towards the opposite side of the sheet body, and then back to the sheet body at an opposite end. The score lines are spaced apart from each other and from the widthwise edges of the sheet body.

### BRIEF DESCRIPTION OF THE DRAWINGS

FIG. 1 provides an elevation view of a blank formable into an embodiment of the cup.

FIG. 2 provides a perspective view of an embodiment of the cup.

FIG. 3 provides an elevation view of a blank formable into another embodiment of the cup.

FIG. 4 provides a perspective view of an embodiment of the cup.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present disclosure concerns a cup which may form its own cover. The cup is generally formed of a single material type or class. Preferably the material may be recyclable, thereby eliminating the need for a separate and different-material cover required by the prior art. Currently, disposable cups and covers are almost always formed of different materials due to the impracticality of making a plastic cup and/or a paper cover. This is especially so for hot drink cups. Accordingly, the present disclosure teaches a cup formed of a single material such as a wax-impregnated paper, plastic-lined paper, or plastic cup, among others, with an integrated folding closure. When closed, the cup forms a drinking spout, with a vent diametrically opposite to the drinking spout.

The cup may begin as a flat blank. On the blank two arc shaped score lines are formed starting and returning at a top and extending to a distance from the top. The two arc shaped score lines are spaced apart from each other and from the two widthwise edges of the blank.

The blank may be formed into a cup by rolling the blank around a mandrel, such as a tapered mandrel, forming seams to connect widthwise ends of the blank, and connecting a base to the bottom of the cup.

Once the cup has been formed, it may be filled with a fluid, such as a drink, for example hot coffee or tea. The cup is filled partially, and in some embodiments may be filled to a recessed or protruding fill line of the cup identifying a maximum recommended fill. The fill line, in some embodiments, may be mark on the blank, such as by a printing, recession, protrusion, or the like. A user may then fold two diametrically opposite sides (“flaps”) of the cup inward, as allowed by the two arc score lines. In most embodiments, the flaps are part of, and integral with, the cup body. The flaps thus formed may engage with each other or may stay in place on their own. This folding causes two spouts on diametrically opposite sides of the cup, and at 90 degrees from the middle of each fold. In many embodiments, one of the spouts may be wider than the other, depending on score line positioning. In such an embodiment, the larger spout is intended for drinking, while the smaller one is intended for venting air to replace the exiting fluid. In a particular embodiment, a seam may be formed on the cup having overlapping layers of the cup material. This reinforced seam area may define the drinking spout portion. It should be understood that any arrangement and operation may be used without straying from the scope of this invention. The cup, so closed, prevents at least an appreciable amount of fluid from leaking through the cover except through the spout, and optionally the vent spout.

In certain embodiments, depending on blank shape, the vent side spout may have a height (as measured from a bottom of the blank) that is less than a drinking spout. This may allow for more ergonomic drinking, in some cases.

The two flaps may be connected to each other when folded inward to form the cover. Connection may be achieved in any number of ways to hold the flaps in place. For example, a pressure sensitive adhesive may be disposed on one or both flaps. In another embodiment, a slit may be formed in each flap, allowing them to interlock when folded downward. In yet another embodiment, a tab may protrude from an edge of a flap which may be engaged through a slit formed in the opposing flap.

The cup thus formed with the integrated closure has many advantages not present in the art. For example, when formed out of recyclable materials, the cup is single-stream recyclable. No separation of components is required. Further, it is more efficient to make a cup that does not require a separate closure because the separate covers need not be made, purchased, shipped, stored, and the like. Moreover, the spout formed by the closure configuration forms a mouthpiece which allows for easy, convenient drinking with less spills than when drinking from an edge of a cup. Further still, the elevation of the spout above the covering flaps decreases spilling because the fluid must elevate beyond the cover to be able to exit the cup through the spout.

The cup and blank of the present invention may be formed of any material. Examples of which the cup and blank may be formed include, but are not limited to, plastics, plastic-lined paper, wax-impregnated paper, paper, and the like. Preferably the material may be easily recyclable and/or compostable, but this is not required.

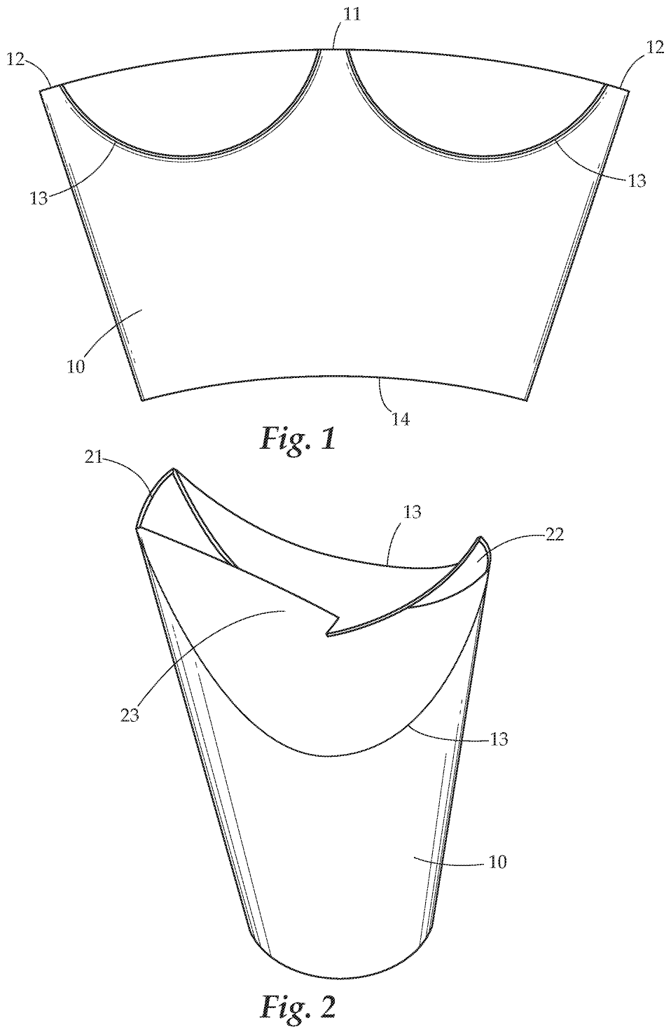

Turning now to FIG. 1, a blank for formation into the cup is shown. The blank has an approximately arched shape, with straight widthwise edges and curved top and bottom edges. In the embodiment shown, the top is wider than the bottom, allowing for formation of a tapered cup. The body 10 is a flat or substantially flat sheet having a bottom edge 14. Two arc shaped scores 13, such as score lines, extend from the top edge downward to a distance from the top edge. The scores 13 are spaced apart from each other and from the widthwise edges, leaving a vent width 11 and two drinking spout widths 12. Though in various embodiment, these may be reversed.

FIG. 2 shows an embodiment of the cup formed from a blank similar to that of FIG. 1 in a closed position such that flaps 23 are folded downward along the scores 13. The cup body has sidewalls and a base (not shown) which define a cavity for the cup to store fluids. The flaps 23 folded as such form a closure as well as a drinking spout 21 and a vent 22. In this view, the drinking spout 21 is formed at a reinforced seam area where two drinking spout widths 12 overlap, having two layers of the blank body 10. The flaps 23 each have a slit allowing interlocking of the two flaps, thereby holding them in place.

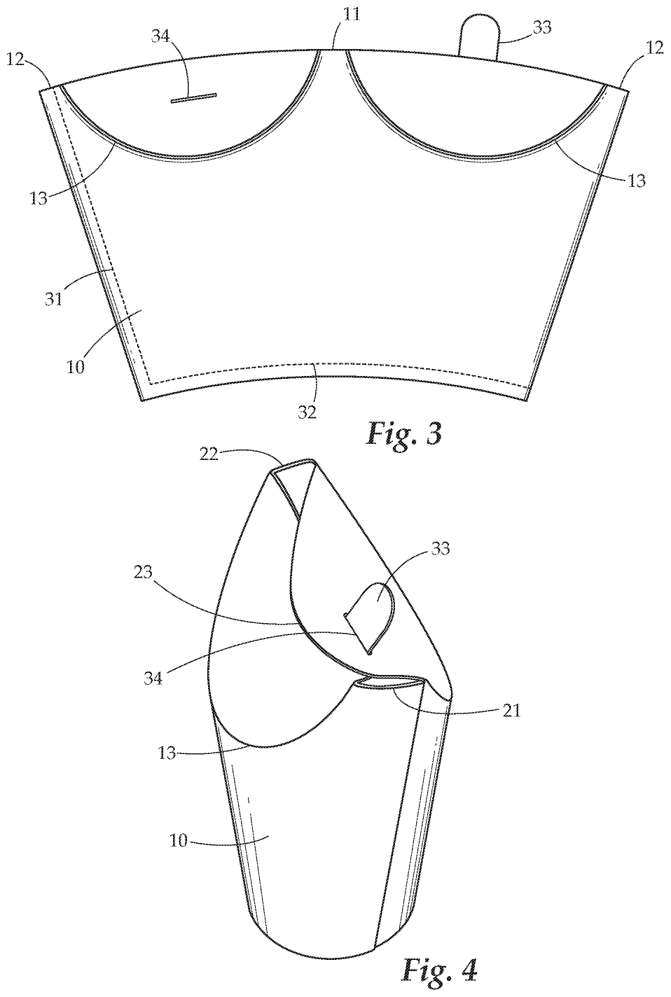

FIG. 3 provides an elevation view of a blank for another embodiment of the cup. The blank body 10 has an approximately arched shape, with straight widthwise edges and curved top and bottom edges. The body 10 is a flat or substantially flat sheet having a bottom edge 14. Two arc shaped scores 13, such as score lines, extend from the top edge downward to a distance from the top edge. The scores 13 are spaced apart from each other and from the widthwise edges, leaving a vent width 11 and two drinking spout widths 12. Though in various embodiment, these may be reversed. A connection line 31 at the end and at the bottom 32 defines an area for the connection of the widthwise ends and a base, respectively. A tab 33 protrudes from one side of the body 10 aligned with the furthest part of the arced score 13. A slit 34 is formed through the body 10 between the score 13 and top edge of the body.

FIG. 4 provides a view of the cup formed by the blank of FIG. 3. In this view, the cup is in a closed position such that flaps 23 are folded downward along the scores 13. The flaps 23 folded as such form a closure as well as a drinking spout 21 and a vent 22. In this view, the drinking spout 21 is formed at a reinforced seam area having two layers of the blank body 10. Tab 33 is extending through slit 34 to hold the flaps 23 closed.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

1. A cup comprising:
a body having side walls and a base and defining a cavity;
two arc shaped score lines formed into the body on opposite sides, the score lines defining a first flap and a second flap for the cup;
the first flap and the second flap folded inward over the cavity forming a closure, each fold being along each score line;
wherein the first flap and the second flap folded inward define a first drinking spout and a second vent spout, the first drinking spout and second vent spout on diametrically opposite sides of the cup from each other; and wherein the first flap defines a first connector and the second flap defines a second connector, the first connector and the second connector configured to engage with one another to form a connection between the first flap and the second flap to hold the flaps in a fixed relationship.

2. The cup of claim 1 wherein the body is formed of a recyclable material.

3. The cup of claim 1 wherein the second vent spout is at a height less than a height of the first drinking spout.

4. The cup of claim 1 wherein the second vent spout is at a height equal to a height of the first drinking spout.

5. (canceled)

6. The cup of claim 1 wherein the first flap defines a first lengthwise connector slit and the second flap defines a second lengthwise connector slit and wherein the first connector slit receives the second flap and the second connector slit receives the first flap to form a connection between the first flap and second flap to hold the flaps in a fixed relationship.

7. The cup of claim 1 wherein the first flap comprises a a connector tab and the second flap comprises a connector slit, the connector tab passing through the connector slit, thereby forming a connection between the first flap and the second flap to hold the flaps in a fixed relationship.

8. The cup of claim 1 wherein the first drinking spout is wider than the second vent spout.

9. The cup of claim 1 wherein the cup is a hot liquid cup.

10. The cup of claim 1 wherein each score line is a recession in a surface of the body.

11. The cup of claim 1 wherein the cup is a tapered cup having a top diameter greater than a bottom diameter.

12. The cup of claim 1 further comprising a seam with overlapping layers, the first drinking spout aligned with the seam.

13. A blank formable into a cup comprising:
a sheet body;
a first arcuate score line and a second arcuate score line formed on the sheet body, each arcuate score line extending from a top edge of the sheet body, the score lines being spaced apart from each other and from each widthwise edge of the sheet body;
the blank further comprising a first connector and a second connector configured to engage with one another to form a connection that connects portions of the sheet body.

14. The blank of claim 13 wherein the first connector is a lengthwise slit formed in the sheet body and the second connector is a tab extending from the top of the sheet body opposite the second arcuate score line.

15. The blank of claim 13 wherein the first connector is a first lengthwise slit formed in the sheet body and the second connector is a second lengthwise slit formed in the sheet body, the first lengthwise slit being opposite the first arcuate score line and the second lengthwise slit being opposite the second arcuate score line.

16. The blank of claim 13 wherein the sheet body is formed of a recyclable material.

17. The blank of claim 13 wherein the sheet body is formed of a material suitable for use with a hot liquid.

18. The blank of claim 13 wherein the sheet body defines a seam area along one widthwise edge of the body.

19. (canceled)

20. A method of forming a cup using the blank of claim 13 comprising the steps of:
obtaining the blank of claim 13;
rolling the blank around a mandrel;
connecting the widthwise edges of the blank after the rolling step; and
attaching a base to the blank to define a bottom of the cup.
